(19) United States
(12) Patent Application Publication
(10) Pub. No.: US 2025/0378813 A1
(43) Pub. Date: Dec. 11, 2025

(54) ELECTRONIC DEVICE AND METHOD OF PROCESSING SOUND

(71) Applicant: CARUX TECHNOLOGY PTE. LTD., SINGAPORE (SG)

(72) Inventors: Yuan-Fu Lin, Tainan (TW); Hsien-Chang Chen, Tainan (TW); Ming-Hong Yao, Tainan (TW)

(73) Assignee: CARUX TECHNOLOGY PTE. LTD., SINGAPORE (SG)

(21) Appl. No.: 19/201,947

(22) Filed: May 8, 2025

(30) Foreign Application Priority Data
Jun. 6, 2024 (CN) 202410731753.3

(51) Int. Cl. G10K 11/178; G06F 3/01

(52) U.S. Cl. CPC G10K 11/1785; G06F 3/016; G10K 2210/129; G10K 2210/3033

(57) ABSTRACT

The disclosure provides an electronic device and a method of processing sound. The electronic device includes a vibration module, a processing element, and a speaker element. The vibration module is configured to generate a first vibration. The first vibration has a first sound signal. The processing element is electrically connected to the vibration module. The processing element is configured to store first anti-sound information. The speaker element is electrically connected to the processing element. When the vibration module generates the first vibration, the processing element converts the first anti-sound information into a first anti-sound signal, and the speaker element is configured to emit the first anti-sound signal. At least one first portion of an amplitude of the first sound signal and at least one second portion of an amplitude of the first anti-sound signal are inverted phases.

### CROSS-REFERENCE TO RELATED APPLICATION

This application claims the priority benefit of China application serial no. 202410731753.3, filed on Jun. 6, 2024. The entirety of the above-mentioned patent application is hereby incorporated by reference herein and made a part of this specification.

### BACKGROUND

### Technical Field

The disclosure relates to an electronic device, and more particularly to an electronic device with a sound processing function and a method of processing sound.

### Description of Related Art

Displays with haptic feedback, regardless of the type of actuator used, will drive the structure to vibrate and generate a certain degree of noise when the actuator operates, and the greater the amplitude of the vibration, the greater the noise. Therefore, the noise will be positively correlated with the tactile sensation. Such a noise is generated by structural vibration and cannot be effectively eliminated. The existing technology uses a passive noise blocking method, but the effect is limited.

### SUMMARY

The disclosure provides an electronic device, including a vibration module, a processing element, and a speaker element. The vibration module is configured to generate a first vibration. The first vibration has a first sound signal. The processing element is electrically connected to the vibration module. The processing element is configured to store first anti-sound information. The speaker element is electrically connected to the processing element. When the vibration module generates the first vibration, the processing element converts the first anti-sound information into a first anti-sound signal, and the speaker element is configured to emit the first anti-sound signal. At least one first portion of an amplitude of the first sound signal and at least one second portion of an amplitude of the first anti-sound signal are inverted phases.

The disclosure provides a method of processing sound, including the following steps. First anti-sound information is stored. A first vibration is generated. The first vibration has a first sound signal. When the first vibration is generated, the first anti-sound information is converted into a first anti-sound signal, and the first anti-sound signal is emitted. At least one first portion of an amplitude of the first sound signal and at least one second portion of an amplitude of the first anti-sound signal are inverted phases.

### BRIEF DESCRIPTION OF THE DRAWINGS

FIG. 1 and FIG. 2 respectively show schematic block diagrams of electronic devices according to different embodiments of the disclosure;

FIG. 3 shows a schematic block diagram of an electronic device according to another embodiment of the disclosure;

FIG. 4 shows a schematic waveform diagram of a sound signal, an anti-sound signal, and a synthesized signal in the embodiment of FIG. 3;

FIG. 5 shows a schematic waveform diagram of a sound signal, an anti-sound signal, and

a synthesized signal according to another embodiment of the disclosure;

FIG. 6 shows a schematic block diagram of an electronic device according to another embodiment of the disclosure;

FIG. 7 shows a schematic diagram of a noise cancelling waveform design according to an embodiment of the disclosure;

FIG. 8 shows a flowchart of steps of a method of processing sound according to an embodiment of the disclosure.

### DESCRIPTION OF THE EMBODIMENTS

The disclosure may be understood by referring to the following detailed description in conjunction with the accompanying drawings. It should be noted that, in order to facilitate understanding and for the concision of the drawings, only a part of the electronic device is shown in the drawings in this disclosure, and the specific elements in the drawings are not drawn according to actual scale. In addition, the number and size of each element in the figure are only exemplary and are not used to limit the scope of the disclosure.

In the following specification and claims, the words “having” and “including” are open-ended words and thus should be interpreted as meaning “including but not limited to.”

It should be understood that although the terms first, second, third, and so on may be used to describe diverse constituent elements, the constituent elements are not limited by the terms. The terms are only used to distinguish one single element from other element in the specification. The same terms may not be used in the claims, and may be replaced with “first,” “second,” “third” and the like in the order in which the elements in the claims are declared. Accordingly, a first element in the following description may be a second element in the claims.

In some embodiments of the disclosure, regarding the words such as “connect,” “interconnected,” etc., referring to bonding and connection, unless specifically defined, these words mean that two structures are in direct contact or two structures are not in direct contact, and other structures are provided to be disposed between the two structures. The word for joining and connecting may also include the case where both structures are movable or both structures are fixed. Furthermore, the term “coupling” includes any direct and indirect means of electrical connection. In the case of direct electrical connection, terminals of elements on two circuits are directly connected or connected to each other by a conductor segment. In the case of indirect electrical connection, there is a switch, a diode, a capacitor, an inductor, a resistor, other suitable elements, or a combination of the above elements between the terminals of the elements on the two circuits, but are not limited thereto.

The electronic device of the disclosure may include a display device, an antenna device, a sensing device, a light emitting device, or a splicing device, but not limited thereto. The electronic device may include a bendable or flexible electronic device. The electronic device may include an electronic element. The electronic device may include, for example, a liquid crystal layer or a light emitting diode (LED). The electronic element may include a passive element and an active element, such as a capacitor, a resistor, an inductor, a variable capacitor, a filter, a diode, a transistor, a sensor, an MEMS, a liquid crystal chip, a controller, etc., but not limited thereto. The diode may include a light emitting diode or a photo diode. The light emitting diode may include, for example, an organic light emitting diode (OLED), a mini LED, a micro LED, a quantum dot LED, fluorescence, phosphor, other suitable materials, or a combination of the above, but not limited thereto. The sensor may include, for example, a capacitive sensor, an optical sensor, an electromagnetic sensor, a fingerprint sensor (FPS), a touch sensor, an antenna, or a pen sensor, etc., but not limited thereto. The controller may include, for example, a timing controller, but not limited thereto. Hereinafter, the display device will be used as an electronic device to illustrate the content of the disclosure, but the disclosure is not limited thereto.

Reference will now be made in detail to the exemplary embodiments of the disclosure, and examples of the exemplary embodiments are illustrated in the accompanying drawings. Whenever possible, the same reference symbols are used in the drawings and descriptions to indicate the same or similar parts.

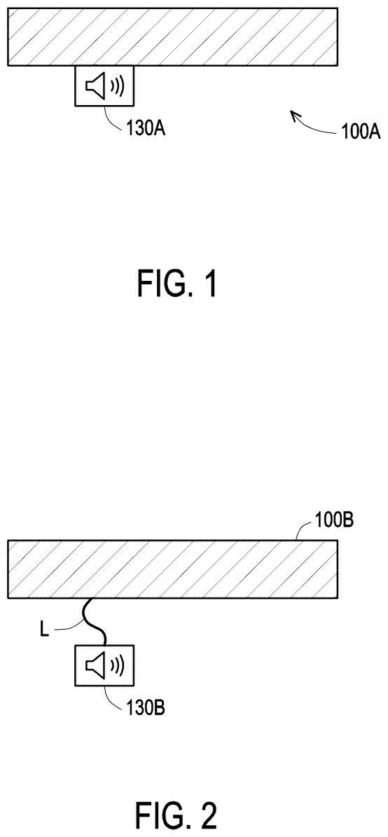

FIG. 1 and FIG. 2 respectively show schematic block diagrams of electronic devices according to different embodiments of the disclosure. Referring to FIG. 1 and FIG. 2, an electronic device 100A and an electronic device 100B are, for example, display devices with a haptic feedback function. The electronic device 100A and the electronic device 100B may be respectively connected to one or more speaker elements 130A and 130B. The speaker elements 130A and 130B can be divided into built-in types and external types.

The speaker element 130A in FIG. 1 is a built-in speaker, which can be built into the electronic device 100A in various ways and integrated with the electronic device 100A. When the electronic device 100A moves, the speaker element 130A also moves accordingly.

The speaker element 130B in FIG. 2 is an external speaker and can be connected to the electronic device 100B via a signal line L. When the signal line L does not exist, the speaker element 130B does not move together with the electronic device 100B.

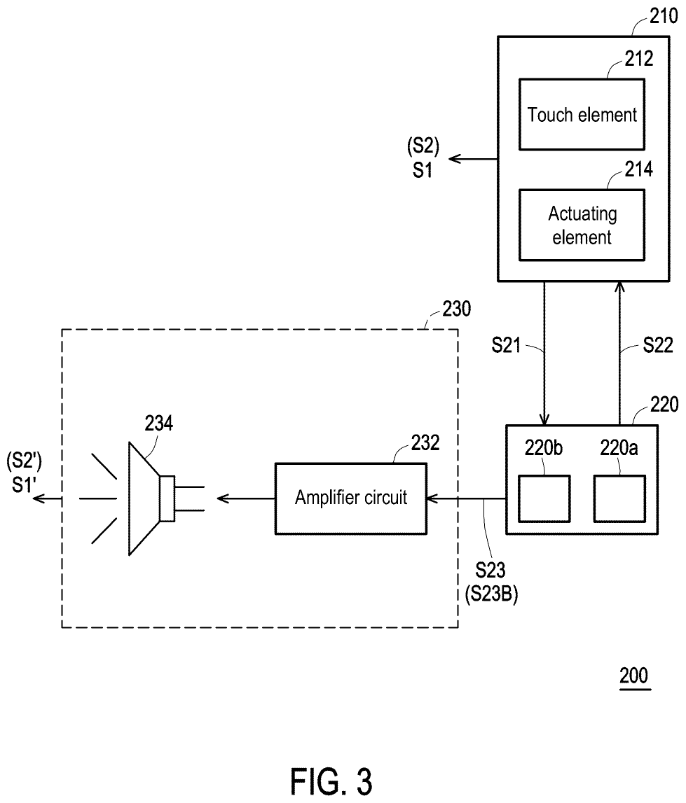

FIG. 3 shows a schematic block diagram of an electronic device according to another embodiment of the disclosure. Referring to FIG. 3, in the embodiment, an electronic device 200 can be used in a transport device. The transport device is an instrument capable of carrying people, including a vehicle, aircraft, or ship. The electronic device 200 includes a vibration module 210, a processing element 220, and a speaker element 230. The vibration module 210 is configured to generate a first vibration. This first vibration has a first sound signal S1 (e.g., initial noise). The processing element 220 is electrically connected to the vibration module 210. The processing element 220 is configured to store first anti-sound information. The speaker element 230 is electrically connected to processing element 220. The speaker element 230 includes an amplifier circuit 232 and a speaker 234. In the embodiment, the speaker element 230 may be a built-in speaker or an external speaker.

The vibration module 210 includes a touch element 212 and an actuating element 214. The touch element 212 is configured to receive a touch operation, such as the pressing of the touch element 212 by the user. The actuating element 214 is configured to generate vibration corresponding to the user's touch operation (e.g., pressing). In the embodiment, the touch element 212 is, for example, a haptic panel. The actuating element 214 includes one or more actuators. The haptic panel uses an actuator as a vibration generation source to transmit a vibration to the display panel via a connected structure to present the tactile sensation. Therefore, when the user touches the haptic panel, the actuator will generate vibration feedback, so that the user can obtain a corresponding touch sensation in accordance with content displayed on the screen.

In the embodiment, the processing element 220 is used to control the operation of the vibration module 210 and generate the signal required for the operation of the actuating element 214. The processing element 220 may include an element 220a and an element 220b. In detail, when the touch element 212 receives a touch operation, the touch element 212 can transmit a signal S21 to the processing element 220, and the processing element 220 (e.g., element 220a) can transmit a signal S22 to the actuating element 214, so that the actuator within the actuating element 214 is caused to vibrate. The signal S22 may be an analog signal and/or a pulse width modulation signal. The element 220a may include a digital-to-analog converter (DAC) and/or a pulse width modulation converter.

The processing element 220 outputs a corresponding first anti-sound signal S1′ (e.g., anti-noise) via the speaker element 230 based on the stored anti-sound information. The first anti-sound signal S1′ can be synthesized with the sound signal S1 in a destructive interference manner, thereby reducing the initial noise S1. Specifically, when the vibration module 210 generates the first vibration, the processing element 220 (e.g., element 220b) may convert the first anti-sound information stored in the processing element 220 into a signal S23. Then, the processing element 220 transmits the signal S23 to the speaker element 230, so that the speaker element 230 amplifies the signal S23 and can emit the first anti-sound signal S1′ via the speaker 234 in the speaker element 230. The speaker element 230 amplifies and outputs the signal S23 transmitted by the processing element 220. The speaker element 230 is configured to emit the first anti-sound signal S1′. Therefore, in the electronic device 200, when the vibration module 210 vibrates and emits a first anti-sound signal S1, the processing element 220 also simultaneously controls the speaker element 230 to emit the first anti-sound signal S1′ to suppress noise. The signal S23 may be an analog signal and/or a pulse width modulation signal. The element 220b may include a digital-to-analog converter and/or a pulse width modulation converter. In some embodiments, the digital first anti-sound information stored in the processing element 220 may be converted into the analog signal S23 via the digital-to-analog converter of the element 220b. The analog signal S23 is then amplified by the speaker element 230 to emit the first anti-sound signal S1′.

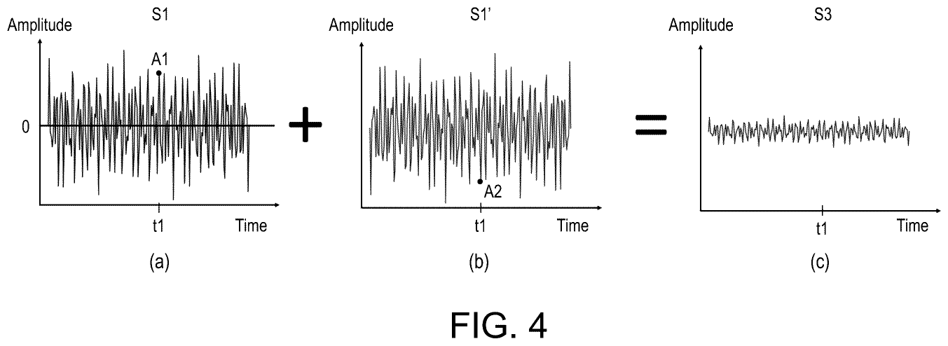

FIG. 4 shows a schematic waveform diagram of the first sound signal S1, the first anti-sound signal S1′, and a synthesized signal S3 in the embodiment of FIG. 3. Referring to FIG. 4, for example, at a given time point t1, as shown in (a) of FIG. 4, an amplitude of the first sound signal S1 is A1. As shown in (b) of FIG. 4, an amplitude A2 of the first anti-sound signal S1′ can be designed to be in the inverted phase to an amplitude A1 of the first sound signal S1, and can be W times the amplitude A1 of the first sound signal S1. Specifically, the amplitude A2 of the first anti-sound signal S1′ can be designed as A2=W×A1, where −2<W<0. In (a) of FIG. 4, the amplitude A1 of the first sound signal S1 at the time point t1 is a positive value as an example. In (b) of FIG. 4, the amplitude A2 of the first anti-sound signal S1′ at the time point t1 is a negative value as an example, but the disclosure is not limited thereto. According to some embodiments, at the time point t1, the amplitude A1 of the first sound signal S1 may be a negative value, and the amplitude A2 of the first anti-sound signal S1′ may be a positive value, which is also within the scope of the disclosure. The above description takes the given time point t1 as an example. Similarly, according to some embodiments, the above description is also applicable to other time points within the time range when the first sound signal S1 is emitted, and the amplitude of the anti-sound signal at other time points may be provided to be in the inverted phase to the amplitude of the first sound signal S1.

Furthermore, in this example, the amplitude of the first anti-sound signal S1′ may be in the inverted phase to the amplitude of the first sound signal S1 in the full frequency band. Therefore, the first anti-sound signal S1′ can destructively interfere with the first sound signal S1 in the full frequency band, and the synthesized signal S3 after the first anti-sound signal S1′ is synthesized with the first sound signal S1 is a low-noise signal, as shown in (c) of FIG. 4. Therefore, the initial noise can be reduced through the active noise cancelling design of the disclosure.

On the other hand, according to some embodiments, based on the required synthesized signal S3, the disclosure can calculate the difference between the first sound signal S1 and the synthesized signal S3 to obtain the first anti-sound signal S1′. Based on the obtained first anti-sound signal S1′, the first anti-sound information can be obtained through the analog-to-digital conversion method, and the digital first anti-sound information can be stored in the processing element 220.

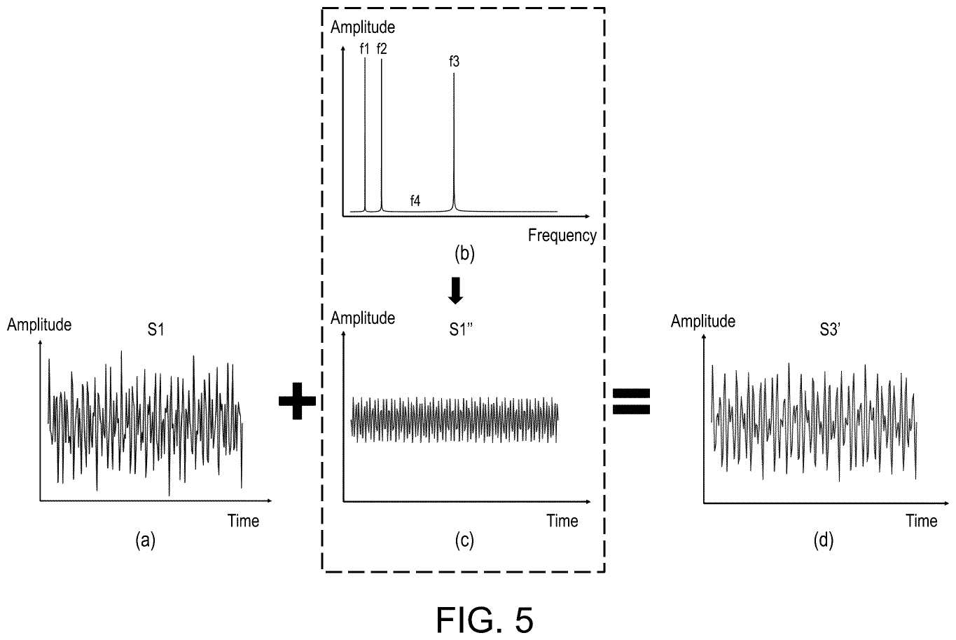

FIG. 5 shows a schematic waveform diagram of the sound signal S1, an anti-sound signal S1″, and a synthesized signal S3′ according to another embodiment of the disclosure. According to some embodiments, the first sound signal S1 may include signals in multiple frequency bands. For example, referring to FIG. 5, in the embodiment, a first anti-sound signal S1″ output by the speaker element 230 can destructively interfere with certain frequency bands of the sound signal S1. For example, the processing element 220 may analyze the first sound signal S1 shown in (a) of FIG. 5 using mathematical calculation methods to obtain its frequency distribution, as shown in (b) of FIG. 5. (b) of FIG. 5 shows the amplitude (e.g., maximum amplitude) distribution of the first sound signal at different frequencies, such as frequencies f1, f2, f3, and f4 shown in (b) of FIG. 5. Then, the processing element 220 generates the first anti-sound signal S1″ corresponding to the frequency band to be eliminated or reduced (for example, frequency bands such as 200 Hz and/or 500 Hz, but the disclosure is not limited thereto). The first anti-sound signal S1″ is played through the speaker element 230, and the purpose is to use the first anti-sound signal S1″ to perform destructive interference to reduce the noise of the first sound signal S1 in a specific frequency band. Therefore, according to some embodiments, the disclosure can perform noise cancelling processing on frequency bands with larger amplitudes in the initial noise.

As mentioned above, according to some embodiments, as shown in FIG. 5, the first sound signal S1 may include signals in multiple frequency bands. In order to interfere with or weaken the sound signal in a specific frequency band, the first anti-sound information stored in the processing element 220 can be designed to correspond to the anti-sound information of each frequency band. In this way, the processing element 220 can convert the first anti-sound information into the first anti-sound signal S1″ according to the specific frequency band.

According to some embodiments, as shown in (b) of FIG. 5, the first sound signal may include a first sub-sound signal S11 at the first frequency f1 and a second sub-sound signal S12 at the second frequency f4. An amplitude of the first sub-sound signal at the first frequency f1 is larger, and an amplitude of the second sub-sound signal at the second frequency f4 is smaller. Suitable anti-sound signals can be provided for sound signals based on requirements. For example, an anti-sound signal having an inverted phase to the amplitude of the first sub-sound signal at a larger frequency (first frequency f1) may be provided, while no anti-sound signal is provided for the amplitude of the second sub-sound signal at a smaller frequency (second frequency f4). That is, the first anti-sound signal at the first frequency f1 is emitted, and the amplitude of the first anti-sound signal and the amplitude of the first sub-sound signal S11 are inverted phases. For the second sub-sound signal S12 at the second frequency f4, no corresponding anti-sound signal is emitted.

Therefore, in the embodiment, at least first portion of the amplitude of the first sound signal S1 (e.g., a part of a frequency band such as 200 Hz and/or 500 Hz) and at least second portion of the amplitude of the first anti-sound signal S1″ are inverted phases. The frequency band of the at least one first portion and the frequency band of the at least one second portion are the same. Therefore, the first anti-sound signal S1″ can destructively interfere with the specific frequency band of the first sound signal S1, and the synthesized signal S3′ after the first anti-sound signal S1″ is synthesized with the first sound signal S1 is also a low-noise signal, and can also reduce the initial noise.

The waveforms of the first sound signal S1, the first anti-sound signals S1′ and S1″, and the synthesized signals S3 and S3′ in FIG. 4 and FIG. 5 are only for illustration and are not intended to limit the disclosure.

In the embodiment of FIG. 3, the processing element 220 is, for example, a processor with a digital-to-analog conversion function. The processing element 220 can directly output the signal to be transmitted to the vibration module 210 via a pin on the processing element 220 to drive the actuating element 214 to vibrate. For example, the processing element 220 can directly output the analog signal and/or the pulse width modulation signal to the vibration module 210 to control and drive the operation of the vibration module 210. In addition, the processing element 220 can also directly output the signal to be transmitted to the speaker element 230 via the pin on the processing element 220. The signal is then output to the speaker 234 via the amplifier circuit 232. For example, the processing element 220 can directly output the analog signal and/or the pulse width modulation signal to drive the speaker element 230 to output the first anti-sound signal S1′.

In the embodiment, the processing element 220 may include a controller or a processor, which is a circuit element with computing capabilities. Alternatively, the controller or processor included in the processing element 220 may be designed through hardware description languages (HDL) or any other digital circuit design method familiar to those skilled in the art, and may be a hardware circuit implemented through a field programmable gate array (FPGA), a complex programmable logic device (CPLD), or an application-specific integrated circuit (ASIC). The disclosure is not limited to implementing the circuit modules in the processing element 220 in software or hardware.

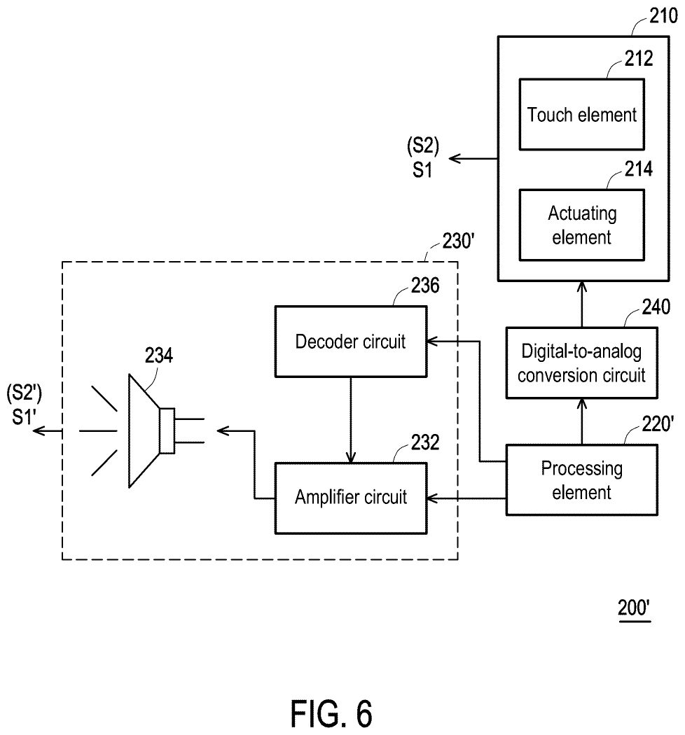

The processing element of the disclosure may also include a processor without a digital-to-analog conversion function. FIG. 6 shows a schematic block diagram of an electronic device according to another embodiment of the disclosure. Referring to FIG. 6, a processing element 220′ does not have the digital-to-analog conversion function. A digital-to-analog conversion circuit 240 can be configured outside the processing element 220′ for performing digital-to-analog conversion operations. The processing element 220′ may transmit the signal to the digital-to-analog conversion circuit 240 via a signal transmission interface such as an inter-integrated circuit (I2C) and/or a serial peripheral interface (SPI). The processing element 220′ informs the digital-to-analog conversion circuit 240 of the signal settings that need to be output, and then the digital-to-analog conversion circuit 240 outputs the signal to the vibration module 210.

On the other hand, a speaker element 230′ further includes a decoder circuit 236. The processing element 220′ can transmit the signal settings to the decoder circuit 236 via an inter-IC Sound (12S), and then the signal is decoded by the decoder circuit 236 and output to the amplifier circuit 232. The first anti-sound signal S1′ is then emitted via the speaker 234.

The noise cancelling waveform design of the disclosure is explained below. Displays with haptic feedback will cause the structure to vibrate and generate a certain degree of noise when the actuator is activated. When the haptic panel architecture is designed, its noise has been roughly determined. Therefore, the disclosure can pre-store the anti-sound information corresponding to the vibration module 210 to the processing element 220. Therefore, in the electronic device 200, when the vibration module 210 vibrates, the processing element 220 can also simultaneously control the speaker element 230 to output the first anti-sound signal S1′ according to the stored anti-sound information to suppress noise.

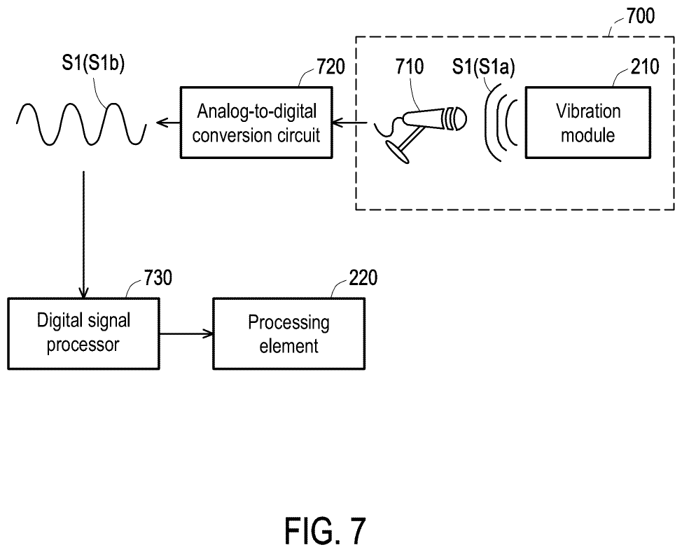

FIG. 7 shows a schematic diagram of a noise cancelling waveform design according to an embodiment of the disclosure. Referring to FIG. 7, taking the electronic device 200 of FIG. 3 as an example, the vibration module 210 is placed in an anechoic chamber or a semi-anechoic chamber 700, so that the vibration module 210 vibrates and the sound is collected through a microphone 710. The microphone 710 outputs the amplified first sound signal S1 to an analog-to-digital conversion circuit 720. The analog-to-digital conversion circuit 720 converts the analog first sound signal S1 (Sla) into the digital first sound signal S1 (S1b). That is, the analog-to-digital conversion circuit 720 converts the noise generated by the vibration of the vibration module 210 into a digital signal. Next, a digital signal processor 730 performs digital signal processing on the first sound signal S1 (S1b), such as filtering processing, reverse processing, and so on. The digital signal processor 730 then stores the processing results as the anti-sound information in the processing element 220.

Referring to FIG. 3, in some embodiments, the vibration module 210 may have multiple vibration modes. The vibration modes may include, for example, the number of vibrations, the force of vibrations, the mode of vibrations, or a combination thereof. For example, when the user performs a touch operation on the same position of the vibration module 210, the vibration of a first vibration mode can be triggered when the touch operation is a pressing, and the vibration of a second vibration mode can be triggered when the touch operation is a rotation. The first vibration in the first vibration mode may, for example, vibrate once, and the second vibration in the second vibration mode may, for example, vibrate twice. For another example, the vibrations in the first vibration mode and the second vibration mode may both be one vibration, but may have different vibration intensities.

The anti-sound information stored in the processing element 220 may include various information corresponding to various vibration modes. In particular, the processing element 220 is configured to store the first anti-sound information and second anti-sound information. For example, the vibration module 210 may have the first vibration mode. The user touches the same position of the vibration module 210. Under the same touch operation and in different first vibration modes, the number of vibrations of the vibration module 210 may be different. For example, in the first vibration mode, the vibration module 210 may vibrate once, and in the second vibration mode, the vibration module 210 may vibrate twice with the same intensity.

In the embodiment of FIG. 3, the vibration module 210 generates the first vibration in the first vibration mode, and the first vibration has the first sound signal S1. The processing element 220 converts the first anti-sound information into the signal S23, and the speaker element 230 emits the first anti-sound signal S1′ to perform active noise cancelling processing on the first sound signal S1. The at least first portion of the amplitude of the first sound signal S1 and at least second portion of the amplitude of the first anti-sound signal S1′ are inverted phases.

The vibration module 210 may also have the second vibration mode. In the embodiment of FIG. 3, the vibration module 210 can also generate a second vibration in the second vibration mode, and the second vibration has a second sound signal S2. When the vibration module 210 generates the second vibration, the processing element 220 converts the second anti-sound information into a signal S23B′, and the signal S23B is transmitted to the speaker element 230, so that the speaker element 230 amplifies the signal S23B and emits a second anti-sound signal S2′. For relevant description of the signal S23B, reference may be made to the foregoing description of the signal S23, and therefore a detailed description will be omitted. The speaker element 230 is configured to emit the second anti-sound signal S2′. At least one third portion of an amplitude of the second sound signal S2 and at least one fourth portion of an amplitude of the second anti-sound signal S2′ are inverted phases.

Since the first sound signal S1 and the second sound signal S2 are sound signals generated in different vibration modes, the first sound signal S1 and the second sound signal S2 are different. In addition, since the first anti-sound signal S1′ and the second anti-sound signal S2′ are anti-sound information corresponding to different vibration modes, the first anti-sound signal S1′ and the second anti-sound signal S2′ are different. Therefore, the processing element 220 can convert the anti-sound information into different anti-sound signals according to different vibration modes.

The above description takes the processing element 220 to store the first anti-sound information and the second anti-sound information as an example, but the disclosure is not limited thereto. According to some embodiments, the processing element 220 may store multiple sets of anti-sound information, such as more than two sets of anti-sound information. When the vibration module 210 generates vibration, the processing element 220 may correspond to the specific anti-sound information in the stored multiple sets of anti-sound information based on the specific sound signal of the specific vibration generated. Furthermore, the processing element 220 can cause the speaker element 230 to emit a specific anti-sound signal corresponding to the specific anti-sound information. In this way, the effect of processing sound, such as reducing noise, can be achieved.

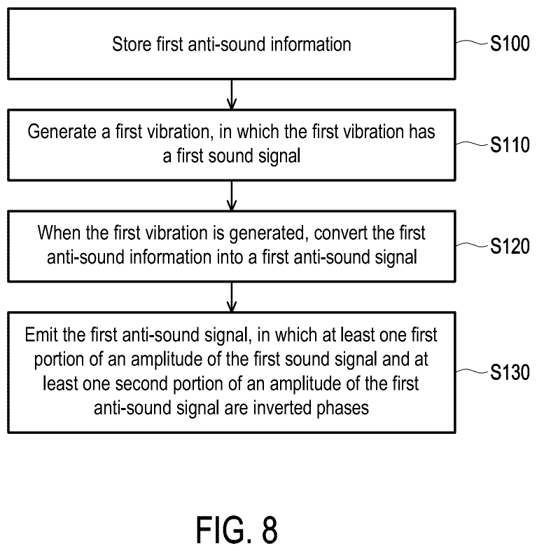

FIG. 8 shows a flowchart of steps of a method of processing sound according to an embodiment of the disclosure. Referring to FIG. 3 and FIG. 8, the noise cancelling method of the embodiment is at least applicable to the electronic device 200 of FIG. 3, but the disclosure is not limited thereto. Taking the electronic device 200 of FIG. 3 as an example, in step S100, the processing element 220 stores the first anti-sound information. In step S110, the vibration module 210 generates the first vibration. The first vibration has the first sound signal S1. In step S120, when the first vibration is generated, the processing element 220 converts the first anti-sound information into the first anti-sound signal S1′. In step S130, the speaker element 230 emits the first anti-sound signal S1′. The at least one first portion of the amplitude of the first sound signal S1 and the at least one second portion of the amplitude of the first anti-sound signal S1′ are inverted phases.

In addition, for the method of processing sound in the embodiment of the disclosure, sufficient teachings, suggestions, and implementation instructions can be obtained from the descriptions of the embodiments of FIG. 1 to FIG. 7, and therefore a detailed description will be omitted.

To sum up, in the embodiment of the disclosure, when the vibration module vibrates to emit the sound signal, the processing element can simultaneously control the speaker element to output the anti-sound signal according to the stored anti-sound information. The amplitude of the anti-sound signal and the amplitude of the sound signal can be inverted phases, so that noise can be suppressed. According to some embodiments, the function of active noise cancelling (ANC) can be achieved. According to some embodiments, the vibration module may be a display device with haptic feedback.

Finally, it should be noted that the foregoing embodiments are only used to illustrate the technical solutions of the disclosure, but not to limit the disclosure; although the disclosure has been described in detail with reference to the foregoing embodiments, persons of ordinary skill in the art should understand that the technical solutions described in the foregoing embodiments can still be modified, or parts or all of the technical features thereof can be equivalently replaced; however, these modifications or substitutions do not deviate the essence of the corresponding technical solutions from the scope of the technical solutions of the embodiments of the disclosure.

What is claimed is:

1. An electronic device, comprising:
a vibration module, configured to generate a first vibration, wherein the first vibration has a first sound signal;
a processing element, electrically connected to the vibration module, and configured to store first anti-sound information; and
a speaker element, electrically connected to the processing element,
wherein when the vibration module generates the first vibration, the processing element is configured to convert the first anti-sound information into a first anti-sound signal, and the speaker element is configured to emit the first anti-sound signal,
wherein at least one first portion of an amplitude of the first sound signal and at least one second portion of an amplitude of the first anti-sound signal are inverted phases.

2. The electronic device according to claim 1, wherein the vibration module comprises:
a touch element, configured to receive a touch operation; and
an actuating element, configured to generate the first vibration corresponding to the touch operation.

3. The electronic device according to claim 1, wherein
the vibration module is configured to generate a second vibration, the second vibration has a second sound signal, the first sound signal and the second sound signal are different, and the processing element is configured to store second anti-sound information.

4. The electronic device according to claim 3, wherein when the vibration module generates the second vibration, the processing element is configured to convert the second anti-sound information into a second anti-sound signal, the speaker element is configured to emit the second anti-sound signal, and the second anti-sound signal and the first anti-sound signal are different.

5. The electronic device according to claim 4, wherein at least one third portion of an amplitude of the second sound signal and at least one fourth portion of an amplitude of the second anti-sound signal are inverted phases.

6. The electronic device according to claim 3, wherein the vibration module has a first vibration mode and a second vibration mode,
wherein in the first vibration mode, the vibration module is configured to generate the first vibration, and in the second vibration mode, the vibration module is configured to generate the second vibration.

7. The electronic device according to claim 1, wherein at a given frequency, the at least first portion of the amplitude of the first sound signal and the at least second portion of the amplitude of the first anti-sound signal are inverted phases.

8. The electronic device according to claim 1, wherein at a given time point, at least first portion of the amplitude of the first anti-sound signal and the at least second portion of the amplitude of the first anti-sound signal are inverted phases.

9. The electronic device according to claim 8, wherein the at least first portion of the amplitude of the first anti-sound signal is W times at least second portion of the amplitude of the first sound signal.

10. The electronic device according to claim 9, wherein-2<W<0.

11. A method of processing sound, comprising:
storing first anti-sound information;
generating a first vibration, wherein the first vibration has a first sound signal;
when the first vibration is generated, converting the first anti-sound information into a first anti-sound signal; and
emitting the first anti-sound signal,
wherein at least one first portion of an amplitude of the first sound signal and at least one second portion of an amplitude of the first anti-sound signal are inverted phases.

12. The method of processing sound according to claim 11, further comprising:
receiving a touch operation; and
generating the first vibration corresponding to the touch operation.

13. The method of processing sound according to claim 11, further comprising:
storing second anti-sound information; and
generating a second vibration, wherein the second vibration has a second sound signal, and the first sound signal and the second sound signal are different.

14. The method of processing sound according to claim 13, further comprising:
when the second vibration is generated, converting the second anti-sound information into a second anti-sound signal, wherein the first anti-sound signal and the second anti-sound signal are different; and
emitting the second anti-sound signal.

15. The method of processing sound according to claim 14, wherein at least one third portion of an amplitude of the second sound signal and at least one fourth portion of an amplitude of the second anti-sound signal are inverted phases.

16. The method of processing sound according to claim 11, wherein the first sound signal comprises a first sub-sound signal at a first frequency and a second sub-sound signal at a second frequency.

17. The method of processing sound according to claim 16, further comprising:
emitting the first anti-sound signal at the first frequency, wherein the amplitude of the first anti-sound signal and an amplitude of the first sub-sound signal are inverted phases.

18. The method of processing sound according to claim 17, further comprising:
not emitting a corresponding anti-sound signal for the second sub-sound signal at the second frequency.

19. The method of processing sound according to claim 11, wherein at least first portion of the amplitude of the first anti-sound signal is W times at least second portion of the amplitude of the first sound signal.

20. The method of processing sound according to claim 19, wherein −2<W<0.
